(19) United States
(12) Patent Application Publication
(10) Pub. No.: US 2006/0018995 A1
(43) Pub. Date: Jan. 26, 2006

(54) Method of preparing a beverage and resulting beverage

(76) Inventor: MacKenzie Smith, Pleasant Hill, CA (US)

Correspondence Address: WEST & ASSOCIATES;A PROFESSIONAL CORPORATION, 2121 NORTH CALIFORNIA BOULEVARD, SUITE 290, WALNUT CREEK, CA, 94596, US

(21) Appl. No.: 10/896,794

(22) Filed: Jul. 21, 2004

(51) Int. Cl. C12C 11/00

(52) U.S. Cl. 426/11

(57) ABSTRACT

A beverage infused with a liquid infusible substance, such as tea. In one embodiment the beverage can be an alcoholic beverage, such as beer or cider.

### BACKGROUND

1. Field of the Invention

The present invention is related to methods of preparing fermented beverages and the resulting beverage. More particularly, the present disclosure relates to a process of producing a beverage infused with a liquid-infusible substance.

2. Background

The process of preparing fermented beverages, such as beer, cider, ale, porter, malt liquor and other similar fermented alcoholic beverages, is historically well established. As practiced in modern breweries, the process, in brief, comprises preparing a mash of malt, usually with cereal adjuncts, and heating the mash to create soluble proteins and convert starches into sugars and dextrins. The insoluble grains are filtered off and washed with hot water, which is combined with the soluble material. The resulting wort is boiled in a brew kettle to inactivate enzymes, sterilize the wort, extract desired hop components from added hops, and coagulate certain protein-like substances. The wort is then strained to remove spent hops and coagulate then cooled and pitched with yeast and fermented. The fermented brew, known as “green” or “ruh” beer, is then aged (“lagered”), clarified, filtered, and carbonated to produce a desired beer.

Teas and other various liquid-infusible substances are known for their medicinal qualities including the abundance of flavinoids (also known as bioflavinoids) that have antioxidant properties and imparting numerous characteristics to beverages. For example phenolic groups in tea leaves combine with peroxides and free radicals decreasing their ability to cause damage to genetic material after invading cell membranes. Teas and other liquid-infusible substances can be sources of valuable nutrients including: carotene, nicotinic acid, folic acid, calcium, manganese, potassium, fluoride, vitamins B1 (thymine), B2 (riboflavin), B6 (pyridoxine) and vitamin C. Tobacco has been linked to increasing concentration levels in humans. The chemical Nicotine in tobacco is a mild stimulant that increases blood pressure and pulse rate. Tobacco suppresses appetite and helps people maintain their body weight.

Both green teas and black teas have been shown to reduce the risk of several types of cancer including digestive tract, and urinary tract cancers. These teas have also been shown to reduce heart disease.

Green teas contain a polyphenol known as epigallocatechin gallate (EGCg) that has been shown to prevent tumor formation in animal studies. Further studies have shown that EGCg kills cancerous cells in the breast while leaving non-cancerous cells unharmed.

Marijuana, another liquid-infusible substance has been shown to reduce inter-ocular pressure in the eye preventing the disease glaucoma, which can lead to blindness from progressing. Marijuana is also used by AIDS patients and cancer patients to stimulate their appetite and counteract weight loss. Other benefits of marijuana include analgesic and pain relief properties produced by its active ingredient THC. It has also been found that marijuana reduces nausea and vomiting effects suffered by cancer patients being treated with chemotherapy.

Known beverage combinations include coffee and beer. In this process brewers add coffee into the beer during conditioning stages. Although coffee has been added to the brewing process, currently there is not a commercially available process to produce liquid infusible beverages, which combines the medicinal effects of tea.

What is needed is a tea or other liquid-infusible substance infused beverage with the soothing medicinal effects of the infused substance.

### BRIEF DESCRIPTION OF THE DRAWINGS

FIG. 1 depicts a process of manufacturing a beverage, which includes the step of adding tea and/or a water infusible substance.

FIG. 2 depicts an alternate process of manufacturing an infused beverage.

FIG. 3 depicts an alternate process of manufacturing an infused beverage.

FIG. 4 depicts an alternate process of manufacturing an infused beverage.

FIG. 5 depicts an alternate process of manufacturing an infused beverage.

FIG. 6 depicts an alternate process of manufacturing an infused beverage.

FIG. 7 depicts an alternate process of manufacturing an infused beverage.

FIG. 8 depicts an alternate process of manufacturing an infused beverage.

FIG. 9 depicts an alternate process of manufacturing an infused beverage.

FIG. 10 depicts an alternate process of manufacturing an infused beverage.

FIG. 11 depicts an alternate process of manufacturing an infused beverage.

FIG. 12 depicts an alternate process of manufacturing an infused beverage.

### DETAILED DESCRIPTION

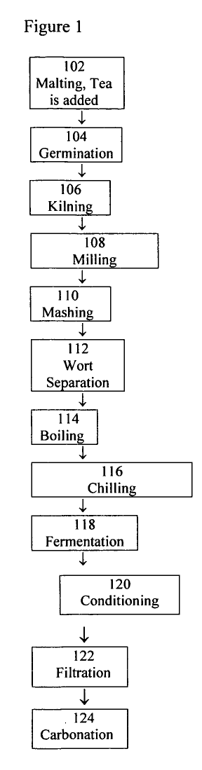

The embodiment shown in FIG. 1 depicts a process of making a beverage that is infused with a tea. In the embodiment shown in FIG. 1 barley kernels are combined with water and malting begins. Barley spends approximately 40 hours in tanks of water wherein the water is drained periodically and subsequently refilled. However, in alternated embodiments this time can be any convenient period. In one embodiment 102, tea can be added in the amount of ¼ lb per 5 gallons of water. However, in alternate embodiments tea or other liquid-infusible substances can be added in any quantity to form a desired taste. Next, moistened barley is germinated 104 by spreading it on a surface in depths of 10-20 cm or using any convenient depth or using any other convenient depth. However, in alternate embodiments germination can be completed in any known or convenient manner. In step 106 of the embodiment shown in FIG. 1, malt kilning is completed by placing green malt into the kiln to dry. Kilning can be performed in any known or convenient manner. After the malt is kilned, the malt can then be milled 108. In the milling process shown in FIG. 1, malt can be cracked open to expose the endosperm. In one embodiment milling is achieved by using a roller mill. Milling can be performed in any known or convenient manner.

After milling is completed and the endosperm is exposed 108, the milled malt and solid adjuncts are mixed with water during mashing 110. In the embodiment shown in FIG. 1, mashing 110 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 110, wort separation 112 can be completed. In one embodiment, mash is transferred to a the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 110 is finished the step of wort boiling 114 can be completed. In one embodiment wort is boiled for at least one hour and hops are added throughout the boil. However, in alternate embodiments any known or convenient method to boil wort can be used.

Subsequent to wort boiling 114, wort-cooling 116 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used.

After the step of wort cooling 116, fermenting 118 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 120 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment secondary fermentation of cask-conditioned beers is induced by adding hops, sugars and yeast. However, in alternate embodiments any known or convenient method to condition green beer can be used or filtration may not be performed.

After the step of conditioning 120, filtration 122 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 124 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 102, tea can be added before, after or during any of the steps described above. Various types of teas and amounts can be used. Furthermore while FIG. 1 and the associated description show the process of making tea infused beer, a similar process may be employed to make cider infused with any liquid infusible substance, using any known or convenient process to make cider.

While FIG. 1 and associated description describe one process for making beer, any known or convenient process can be used. Moreover while the steps of FIG. 1 are depicted in a specific sequence, the steps may be conducted in any known of convenient order. Additionally, in alternate embodiments additional known or convenient steps may be added and/or various steps may not be performed in order to produce various tastes and/or textures.

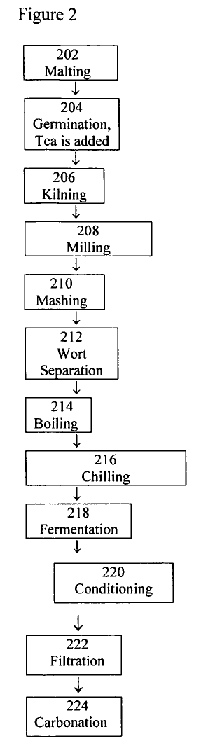

The embodiment shown in FIG. 2 depicts a process of making a beverage that is infused with a tea. In the embodiment shown in FIG. 2 barley kernels are combined with water and malting begins. Barley spends approximately 40 hours in tanks of water wherein the water is drained periodically and subsequently refilled. However, this time can be any convenient period. Next, moistened barley is germinated 204 by spreading it on a surface. In one embodiment the barley is spread on a surface in depths of 10-20 cm or using any convenient depth. However, in alternate embodiments germination can be completed in any known or convenient manner. In the embodiment detailed above 204, tea can be added in the amount of ⅙ lb per 5 lbs of barley. However, in alternate embodiments tea or other liquid-infusible substances can be added in any quantity to form a desired taste.

In step 206 of the embodiment shown in FIG. 2, malt kilning is completed by placing green malt into the kiln to dry. Kilning can be performed in any known or convenient manner. After the malt is kilned, the malt can then be milled 108. In the milling process shown in FIG. 2, malt can be cracked open to expose the endosperm. In one embodiment milling is achieved by using a roller mill. Milling can be performed in any known or convenient manner. After milling is completed and the endosperm is exposed 208, the milled malt and solid adjuncts are mixed with water during mashing 210. In the embodiment shown in FIG. 2, mashing 210 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 210, wort separation 212 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 210 is finished the step of wort boiling 214 can be completed. In one embodiment wort is boiled for at least one hour and hops are added throughout the boil. However, in alternate embodiments any known or convenient method to boil wort can be used.

Subsequent to wort boiling 214, wort-cooling 216 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used. After the step of wort cooling 216, fermenting 218 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 220 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used.

After the step of conditioning 220, filtration 222 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 224 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 204 tea can be added before, after or during any of the steps described above. Various types of teas and amounts can be used. Furthermore while FIG. 2 and the associated description show the process of making tea infused beer, a similar process may be employed to make cider infused with any liquid infusible substance, using any known or convenient process to make cider.

While FIG. 2 and associated description describe one process for making beer, any known or convenient process can be used. Moreover while the steps of FIG. 2 are depicted in a specific sequence, the steps may be conducted in any known of convenient order. Additionally, in alternate embodiments additional known or convenient steps may be added and/or various steps may not be performed in order to produce various tastes and/or textures.

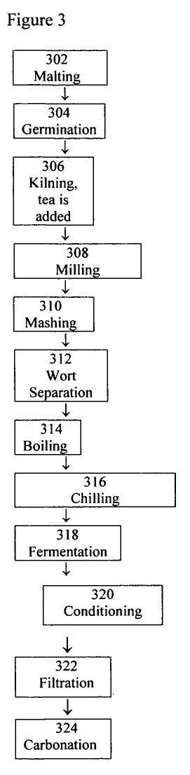

The embodiment shown in FIG. 3 depicts a process of making a beverage that is infused with a tea. In the embodiment shown in FIG. 3 barley kernels are combined with water and malting begins. Barley spends approximately 40 hours in tanks of water wherein the water is drained periodically and subsequently refilled. However, this time can be any convenient period. Next, moistened barley is germinated 304 by spreading it on a surface. In one embodiment the barley is spread on a surface in depths of 10-20 cm or using any convenient depth. However, in alternate embodiments germination can be completed in any known or convenient manner.

In step 306 of the embodiment shown in FIG. 3, malt kilning is completed by placing green malt into the kiln to dry. Kilning can be performed in any known or convenient manner. After the malt is kilned, the malt can then be milled 308. In the milling process shown in FIG. 3, malt can be cracked open to expose the endosperm. In one embodiment milling is achieved by using a roller mill. Milling can be performed in any known or convenient manner. In the embodiment detailed above 306, tea can be added in the amount of ½ lb per 5 lbs of barley. However, in alternate embodiments tea or other liquid-infusible substances can be added in any quantity to form a desired taste.

After milling is completed and the endosperm is exposed 308, the milled malt and solid adjuncts are mixed with water during mashing 310. In the embodiment shown in FIG. 3, mashing 310 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 310, wort separation 312 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 310 is finished the step of wort boiling 314 can be completed. In one embodiment wort is boiled for at least one hour and hops are added throughout the boil. However, in alternate embodiments any known or convenient method to boil wort can be used.

Subsequent to wort boiling 314, wort-cooling 316 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used.

After the step of wort cooling 316, fermenting 318 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 320 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used. After the step of conditioning 320, filtration 322 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 324 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 306, tea can be added before, after or during any of the steps described above. Various types of teas and amounts can be used. Furthermore while FIG. 3 and the associated description show the process of making tea infused beer, a similar process may be employed to make cider infused with any liquid infusible substance, using any known or convenient process to make cider.

While FIG. 3 and associated description describe one process for making beer, any known or convenient process can be used. Moreover while the steps of FIG. 3 are depicted in a specific sequence, the steps may be conducted in any known of convenient order. Additionally, in alternate embodiments additional known or convenient steps may be added and/or various steps may not be performed in order to produce various tastes and/or textures.

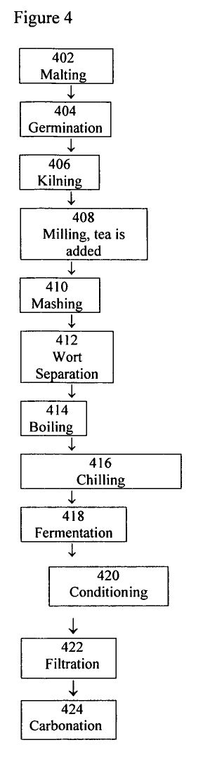

The embodiment shown in FIG. 4 depicts a process of making a beverage that is infused with a tea. In the embodiment shown in FIG. 4 barley kernels are combined with water and malting begins. Barley spends approximately 40 hours in tanks of water wherein the water is drained periodically and subsequently refilled. However, this time can be any convenient period. Next, moistened barley is germinated 404 by spreading it on a surface. In one embodiment the barley is spread on a surface in depths of 10-20 cm or using any convenient depth. However, in alternate embodiments germination can be completed in any known or convenient manner. In step 406 of the embodiment shown in FIG. 4, malt kilning is completed by placing green malt into the kiln to dry. Kilning can be performed in any known or convenient manner. After the malt is kilned, the malt can then be milled 408. In the milling process shown in FIG. 4, malt can be cracked open to expose the endosperm. In one embodiment milling is achieved by using a roller mill. Milling can be performed in any known or convenient manner. In the embodiment detailed above 408, tea can be added in the amount of 1/10 lb per 5 lbs of barley. However, in alternate embodiments tea or other liquid-infusible substances can be added in any quantity to form a desired taste.

After milling is completed and the endosperm is exposed 408, the milled malt and solid adjuncts are mixed with water during mashing 410. In the embodiment shown in FIG. 4, mashing 410 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 410, wort separation 412 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 410 is finished the step of wort boiling 414 can be completed. In one embodiment wort is boiled for at least one hour and hops are added throughout the boil. However, in alternate embodiments any known or convenient method to boil wort can be used.

Subsequent to wort boiling 414, wort-cooling 416 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used.

After the step of wort cooling 416, fermenting 418 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 420 is completed. During conditioning the green beer is matured. [0064] In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used. After the step of conditioning 420, filtration 422 can be completed. Filtration is employed to remove residual yeast. In one embodiment powderfilters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 424 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 408, tea can be added before, after or during any of the steps described above. Various types of teas and amounts can be used. Furthermore while FIG. 4 and the associated description show the process of making tea infused beer, a similar process may be employed to make cider infused with any liquid infusible substance, using any known or convenient process to make cider.

While FIG. 4 and associated description describe one process for making beer, any known or convenient process can be used. Moreover while the steps of FIG. 4 are depicted in a specific sequence, the steps may be conducted in any known of convenient order. Additionally, in alternate embodiments additional known or convenient steps may be added and/or various steps may not be performed in order to produce various tastes and/or textures.

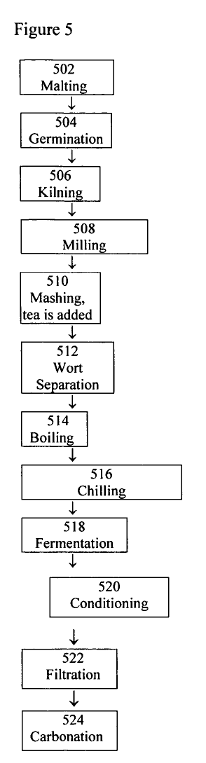

The embodiment shown in FIG. 5 depicts a process of making a beverage that is infused with a tea. In the embodiment shown in FIG. 5 barley kernels are combined with water and malting begins. Barley spends approximately 40 hours in tanks of water wherein the water is drained periodically and subsequently refilled. However, this time can be any convenient period. Next, moistened barley is germinated 504 by spreading it on a surface. In one embodiment the barley is spread on a surface in depths of 10-20 cm or using any convenient depth. However, in alternate embodiments germination can be completed in any known or convenient manner. In step 506 of the embodiment shown in FIG. 5, malt kilning is completed by placing green malt into the kiln to dry. Kilning can be performed in any known or convenient manner. After the malt is kilned, the malt can then be milled 508. In the milling process shown in FIG. 5, malt can be cracked open to expose the endosperm. In one embodiment milling is achieved by using a roller mill. Milling can be performed in any known or convenient manner. After milling is completed and the endosperm is exposed 508, the milled malt and solid adjuncts are mixed with water during mashing 510. In the embodiment shown in FIG. 5, mashing 510 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used. In the embodiment detailed above 510, tea can be added in the amount of ½ lb per 5 gallons of water. However, in alternate embodiments tea or other liquid-infusible substances can be added in any quantity to form a desired taste.

After the step of mashing 510, wort separation 512 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used. Once mashing 510 is finished the step of wort boiling 514 can be completed. In one embodiment wort is boiled for at least one hour and hops are added throughout the boil. However, in alternate embodiments any known or convenient method to boil wort can be used.

Subsequent to wort boiling 514, wort-cooling 516 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used.

After the step of wort cooling 516, fermenting 518 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 520 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used. After the step of conditioning 520, filtration 522 can be completed. Filtration is employed to remove residual yeast. In one embodiment powderfilters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 524 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 510 tea can be added before, after or during any of the steps described above. Various types of teas and amounts can be used. Furthermore while FIG. 5 and the associated description show the process of making tea infused beer, a similar process may be employed to make cider infused with any liquid infusible substance, using any known or convenient process to make cider.

While FIG. 5 and associated description describe one process for making beer, any known or convenient process can be used. Moreover while the steps of FIG. 5 are depicted in a specific sequence, the steps may be conducted in any known of convenient order. Additionally, in alternate embodiments additional known or convenient steps may be added and/or various steps may not be performed in order to produce various tastes and/or textures.

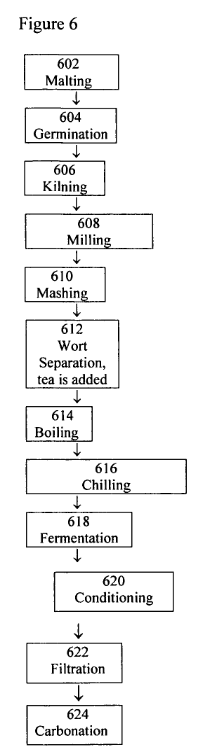

The embodiment shown in FIG. 6 depicts a process of making a beverage that is infused with a tea. In the embodiment shown in FIG. 6 barley kernels are combined with water and malting begins. Barley spends approximately 40 hours in tanks of water wherein the water is drained periodically and subsequently refilled. However, this time can be any convenient period. Next, moistened barley is germinated 604 by spreading it on a surface. In one embodiment the barley is spread on a surface in depths of 10-20 cm or using any convenient depth. However, in alternate embodiments germination can be completed in any known or convenient manner.

In step 606 of the embodiment shown in FIG. 6, malt kilning is completed by placing green malt into the kiln to dry. Kilning can be performed in any known or convenient manner. After the malt is kilned, the malt can then be milled 608. In the milling process shown in FIG. 6, malt can be cracked open to expose the endosperm. In one embodiment milling is achieved by using a roller mill. Milling can be performed in any known or convenient manner. After milling is completed and the endosperm is exposed 608, the milled malt and solid adjuncts are mixed with water during mashing 610. In the embodiment shown in FIG. 6, mashing 610 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 610, wort separation 612 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used. In the embodiment detailed above 610, tea can be added in the amount of ⅛ lb per 5 gallons of wort. However, in alternate embodiments tea or other liquid-infusible substances can be added in any quantity to form a desired taste.

Once mashing 610 is finished the step of wort boiling 614 can be completed. In one embodiment wort is boiled for at least one hour and hops are added throughout the boil. However, in alternate embodiments any known or convenient method to boil wort can be used.

Subsequent to wort boiling 614, wort-cooling 616 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used. After the step of wort cooling 616, fermenting 618 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 620 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used. After the step of conditioning 620, filtration 622 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 624 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 612 tea can be added before, after or during any of the steps described above. Various types of teas and amounts can be used. Furthermore while FIG. 6 and the associated description show the process of making tea infused beer, a similar process may be employed to make cider infused with any liquid infusible substance, using any known or convenient process to make cider.

While FIG. 6 and associated description describe one process for making beer, any known or convenient process can be used. Moreover while the steps of FIG. 6 are depicted in a specific sequence, the steps may be conducted in any known of convenient order. Additionally, in alternate embodiments additional known or convenient steps may be added and/or various steps may not be performed in order to produce various tastes and/or textures.

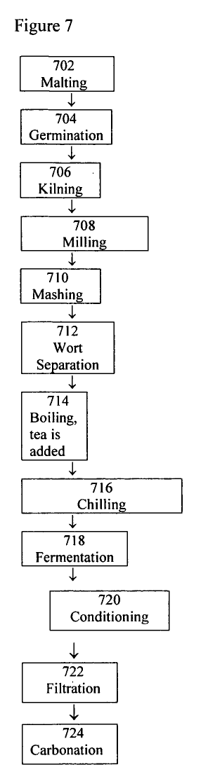

The embodiment shown in FIG. 7 depicts a process of making a beverage that is infused with a tea. In the embodiment shown in FIG. 7 barley kernels are combined with water and malting begins. Barley spends approximately 40 hours in tanks of water wherein the water is drained periodically and subsequently refilled. However, this time can be any convenient period. Next, moistened barley is germinated 704 by spreading it on a surface. In one embodiment the barley is spread on a surface in depths of 10-20 cm or using any convenient depth. However, in alternate embodiments germination can be completed in any known or convenient manner.

In step 706 of the embodiment shown in FIG. 7, malt kilning is completed by placing green malt into the kiln to dry. Kilning can be performed in any known or convenient manner. After the malt is kilned, the malt can then be milled 708. In the milling process shown in FIG. 7, malt can be cracked open to expose the endosperm. In one embodiment milling is achieved by using a roller mill. Milling can be performed in any known or convenient manner. After milling is completed and the endosperm is exposed 708, the milled malt and solid adjuncts are mixed with water during mashing 710. In the embodiment shown in FIG. 7, mashing 710 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 710, wort separation 712 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 710 is finished the step of wort boiling 714 can be completed. In one embodiment wort is boiled for at least one hour and hops are added throughout the boil. However, in alternate embodiments any known or convenient method to boil wort can be used. In the embodiment detailed above 714, tea can be added in the amount of 1/16 lb per 5 lbs gallons of wort. However, in alternate embodiments tea or other liquid-infusible substances can be added in any quantity to form a desired taste.

Subsequent to wort boiling 714, wort-cooling 716 can be completed. In one embodiment wort is cooled on heat plate exchangers in a single stage utilizing chilled water and the cold break is removed. In another embodiment wort is cooled in multiple stages with ambient water and glycol and the, cold break is removed. However, in alternate embodiments any known or convenient method to cool wort can be used.

After the step of wort cooling 716, fermenting 718 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 720 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used.

After the step of conditioning 720, filtration 722 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 724 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 714 tea can be added before, after or during any of the steps described above. Various types of teas and amounts can be used. Furthermore while FIG. 7 and the associated description show the process of making tea infused beer, a similar process may be employed to make cider infused with any liquid infusible substance, using any known or convenient process to make cider.

While FIG. 7 and associated description describe one process for making beer, any known or convenient process can be used. Moreover while the steps of FIG. 7 are depicted in a specific sequence, the steps may be conducted in any known of convenient order. Additionally, in alternate embodiments additional known or convenient steps may be added and/or various steps may not be performed in order to produce various tastes and/or textures.

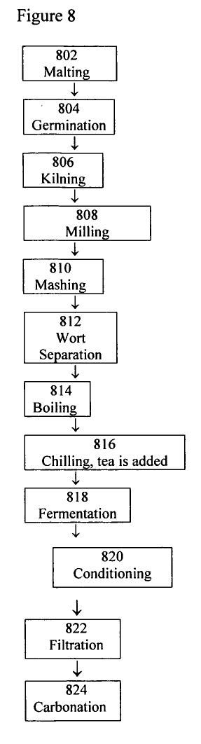

The embodiment shown in FIG. 8 depicts a process of making a beverage that is infused with a tea. In the embodiment shown in FIG. 8 barley kernels are combined with water and malting begins. Barley spends approximately 40 hours in tanks of water wherein the water is drained periodically and subsequently refilled. However, this time can be any convenient period. Next, moistened barley is germinated 804 by spreading it on a surface. In one embodiment the barley is spread on a surface in depths of 10-20 cm or using any convenient depth. However, in alternate embodiments germination can be completed in any known or convenient manner.

In step 806 of the embodiment shown in FIG. 8, malt kilning is completed by placing green malt into the kiln to dry. Kilning can be performed in any known or convenient manner. After the malt is kilned, the malt can then be milled 808. In the milling process shown in FIG. 8, malt can be cracked open to expose the endosperm. In one embodiment milling is achieved by using a roller mill. Milling can be performed in any known or convenient manner.

After milling is completed and the endosperm is exposed 808, the milled malt and solid adjuncts are mixed with water during mashing 810. In the embodiment shown in FIG. 8, mashing 810 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 810, wort separation 812 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 810 is finished the step of wort boiling 814 can be completed. In one embodiment wort is boiled for at least one hour and hops are added throughout the boil. However, in alternate embodiments any known or convenient method to boil wort can be used.

Subsequent to wort boiling 814, wort-cooling 816 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used. In the embodiment detailed above 816, tea can be added in the amount of ⅓ lb per 5 gallons of wort. However, in alternate embodiments tea or other liquid-infusible substances can be added in any quantity to form a desired taste. After the step of wort cooling 816, fermenting 818 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 820 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used.

After the step of conditioning 820, filtration 822 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 824 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 816, tea can be added before, after or during any of the steps described above. Various types of teas and amounts can be used. Furthermore while FIG. 8 and the associated description show the process of making tea infused beer, a similar process may be employed to make cider infused with any liquid infusible substance, using any known or convenient process to make cider.

While FIG. 8 and associated description describe one process for making beer, any known or convenient process can be used. Moreover while the steps of FIG. 8 are depicted in a specific sequence, the steps may be conducted in any known of convenient order. Additionally, in alternate embodiments additional known or convenient steps may be added and/or various steps may not be performed in order to produce various tastes and/or textures.

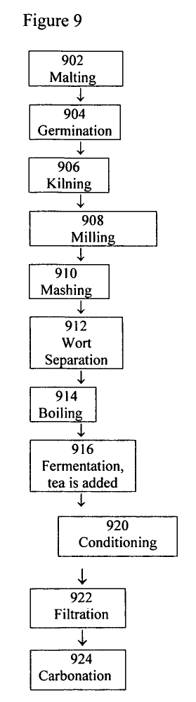

The embodiment shown in FIG. 9 depicts a process of making a beverage that is infused with a tea. In the embodiment shown in FIG. 9 barley kernels are combined with water and malting begins. Barley spends approximately 40 hours in tanks of water wherein the water is drained periodically and subsequently refilled. However, this time can be any convenient period. Next, moistened barley is germinated 904 by spreading it on a surface. In one embodiment the barley is spread on a surface in depths of 10-20 cm or using any convenient depth. However, in alternate embodiments germination can be completed in any known or convenient manner.

In step 906 of the embodiment shown in FIG. 9, malt kilning is completed by placing green malt into the kiln to dry. Kilning can be performed in any known or convenient manner. After the malt is kilned, the malt can then be milled 908. In the milling process shown in FIG. 9, malt can be cracked open to expose the endosperm. In one embodiment milling is achieved by using a roller mill. Milling can be performed in any known or convenient manner. After milling is completed and the endosperm is exposed 908, the milled malt and solid adjuncts are mixed with water during mashing 910. In the embodiment shown in FIG. 9, mashing 910 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 910, wort separation 912 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 910 is finished the step of wort boiling 914 can be completed. In one embodiment wort is boiled for at least one hour and hops are added throughout the boil. However, in alternate embodiments any known or convenient method to boil wort can be used.

Subsequent to wort boiling 914, wort-cooling 916 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used.

After the step of wort cooling 916, fermenting 918 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used. In the embodiment detailed above 918, tea can be added in the amount of 1 and ¼ lb per 5 gallons of wort. However, in alternate embodiments tea or other liquid-infusible substances can be added in any quantity to form a desired taste.

Next conditioning 920 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used. After the step of conditioning 920, filtration 922 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

While this embodiment depicts tea as being added at step 916 tea can be added before, after or during any of the steps described above. Various types of teas and amounts can be used. Furthermore while FIG. 9 and the associated description show the process of making tea infused beer, a similar process may be employed to make cider infused with any liquid infusible substance, using any known or convenient process to make cider.

While FIG. 9 and associated description describe one process for making beer, any known or convenient process can be used. Moreover while the steps of FIG. 9 are depicted in a specific sequence, the steps may be conducted in any known of convenient order. Additionally, in alternate embodiments additional known or convenient steps may be added and/or various steps may not be performed in order to produce various tastes and/or textures.

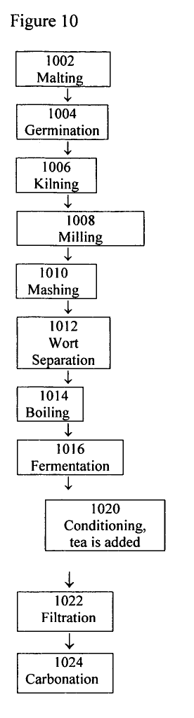

The embodiment shown in FIG. 10 depicts a process of making a beverage that is infused with a tea. In the embodiment shown in FIG. 10 barley kernels are combined with water and malting begins. Barley spends approximately 40 hours in tanks of water wherein the water is drained periodically and subsequently refilled. However, this time can be any convenient period. Next, moistened barley is germinated 1004 by spreading it on a surface. In one embodiment the barley is spread on a surface in depths of 10-20 cm or using any convenient depth. However, in alternate embodiments germination can be completed in any known or convenient manner.

In step 1006 of the embodiment shown in FIG. 10, malt kilning is completed by placing green malt into the kiln to dry. Kilning can be performed in any known or convenient manner. After the malt is kilned, the malt can then be milled 1008. In the milling process shown in FIG. 10, malt can be cracked open to expose the endosperm. In one embodiment milling is achieved by using a roller mill. Milling can be performed in any known or convenient manner.

After milling is completed and the endosperm is exposed 1008, the milled malt and solid adjuncts are mixed with water during mashing 1010. In the embodiment shown in FIG. 10, mashing 1010 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 1010, wort separation 1012 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 1010 is finished the step of wort boiling 1014 can be completed. In one embodiment wort is boiled for at least one hour and hops are added throughout the boil. However, in alternate embodiments any known or convenient method to boil wort can be used.

Subsequent to wort boiling 1014, wort-cooling 1016 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used.

After the step of wort cooling 1016, fermenting 1018 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 1020 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used. In the embodiment detailed above 1020, tea can be added in the amount of 1 and ½ lb per 5 gallons of green beer. However, in alternate embodiments tea or other liquid-infusible substances can be added in any quantity to form a desired taste.

After the step of conditioning 1020, filtration 1022 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 1024 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 1020 tea can be added before, after or during any of the steps described above. Various types of teas and amounts can be used. Furthermore while FIG. 10 and the associated description show the process of making tea infused beer, a similar process may be employed to make cider infused with any liquid infusible substance, using any known or convenient process to make cider.

While FIG. 10 and associated description describe one process for making beer, any known or convenient process can be used. Moreover while the steps of FIG. 10 are depicted in a specific sequence, the steps may be conducted in any known of convenient order. Additionally, in alternate embodiments additional known or convenient steps may be added and/or various steps may not be performed in order to produce various tastes and/or textures.

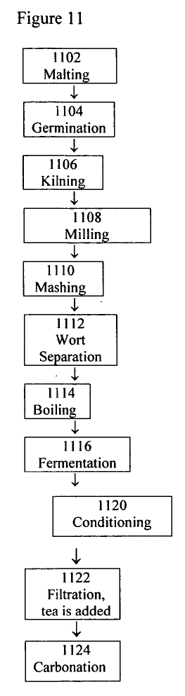

The embodiment shown in FIG. 11 depicts a process of making a beverage that is infused with a tea. In the embodiment shown in FIG. 11 barley kernels are combined with water and malting begins. Barley spends approximately 40 hours in tanks of water wherein the water is drained periodically and subsequently refilled. However, this time can be any convenient period. Next, moistened barley is germinated 1104 by spreading it on a surface. In one embodiment the barley is spread on a surface in depths of 10-20 cm or using any convenient depth. However, in alternate embodiments germination can be completed in any known or convenient manner.

In step 1106 of the embodimentshown in FIG. 11, malt kilning is completed by placing green malt into the kiln to dry. Kilning can be performed in any known or convenient manner. After the malt is kilned, the malt can then be milled 1108. In the milling process shown in FIG. 11, malt can be cracked open to expose the endosperm. In one embodiment milling is achieved by using a roller mill. Milling can be performed in any known or convenient manner. After milling is completed and the endosperm is exposed 1108, the milled malt and solid adjuncts are mixed with water during mashing 1110. In the embodiment shown in FIG. 11, mashing 1110 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 1110, wort separation 1112 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 1110 is finished the step of wort boiling 1114 can be completed. In one embodiment wort is boiled for at least one hour and hops are added throughout the boil. However, in alternate embodiments any known or convenient method to boil wort can be used.

Subsequent to wort boiling 1114, wort-cooling 1116 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used. After the step of wort cooling 1116, fermenting 1118 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 1120 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used.

After the step of conditioning 1120, filtration 1122 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted. In the embodiment detailed above 1122, tea can be added in the amount of 1 and ¾ lb per 5 gallons of beer. However, in alternate embodiments tea or other liquid-infusible substances can be added in any quantity to form a desired taste.

Next carbonation 1124 is completed. In one embodiment mechanical carbonation is accomplished by adding carbon dioxide gas to the filtered beverage. However, in alternate embodiments any known or convenient method to carbonate beer can be used.

While this embodiment depicts tea as being added at step 1122 tea can be added before, after or during any of the steps described above. Various types of teas and amounts can be used. Furthermore while FIG. 11 and the associated description show the process of making tea infused beer, a similar process may be employed to make cider infused with any liquid infusible substance, using any known or convenient process to make cider.

While FIG. 11 and associated description describe one process for making beer, any known or convenient process can be used. Moreover while the steps of FIG. 11 are depicted in a specific sequence, the steps may be conducted in any known of convenient order. Additionally, in alternate embodiments additional known or convenient steps may be added and/or various steps may not be performed in order to produce various tastes and/or textures.

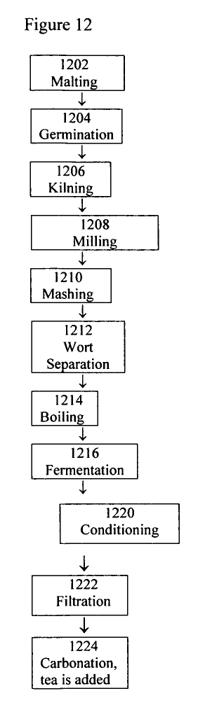

The embodiment shown in FIG. 12 depicts a process of making a beverage that is infused with a tea. In the embodiment shown in FIG. 12 barley kernels are combined with water and malting begins. Barley spends approximately 40 hours in tanks of water wherein the water is drained periodically and subsequently refilled. However, this time can be any convenient period. Next, moistened barley is germinated 1204 by spreading it on a surface. In one embodiment the barley is spread on a surface in depths of 10-20 cm or using any convenient depth. However, in alternate embodiments germination can be completed in any known or convenient manner.

In step 1206 of the embodiment shown in FIG. 12, malt kilning is completed by placing green malt into the kiln to dry. Kilning can be performed in any known or convenient manner. After the malt is kilned, the malt can then be milled 1208. In the milling process shown in FIG. 12, malt can be cracked open to expose the endosperm. In one embodiment milling is achieved by using a roller mill. Milling can be performed in any known or convenient manner. After milling is completed and the endosperm is exposed 1208, the milled malt and solid adjuncts are mixed with water during mashing 1210. In the embodiment shown in FIG. 12, mashing 1210 includes mixing warm water with milled grain in a vessel such that enzymes can convert proteins and starches to simple sugars. In one embodiment, water can be adjusted during mashing by adding mineral salts to adjust the pH of the mixture and produce the desired pH profile between 5.5 and 5.6 for mashing. However, in alternate embodiments any known or convenient method for mashing can be used and various pH profiles can be used.

After the step of mashing 1210, wort separation 1212 can be completed. In one embodiment, mash is transferred to the lauter tun. Sweet wort is run off into the brew kettle and the mash is rinsed with hot water. In another embodiment sweet wort is transferred to the mash tun where the mash is sparged and grains are extracted. However, in alternate embodiments any known or convenient method to separate wort can be used.

Once mashing 1210 is finished the step of wort boiling 1214 can be completed. In one embodiment wort is boiled for at least one hour and hops are added throughout the boil. However, in alternate embodiments any known or convenient method to boil wort can be used.

Subsequent to wort boiling 1214, wort-cooling 1216 can be completed. In one embodiment wort is cooled on heat plate exchangers in a single stage utilizing chilled water and the cold break is removed. In another embodiment wort is cooled in multiple stages with ambient water and glycol and the cold break is removed. However, in alternate embodiments any known or convenient method to cool wort can be used.

After the step of wort cooling 1216, fermenting 1218 can be completed. Chilled wort is transferred to the fermenter and yeast is pitched beginning the fermentation process. Yeast is pitched into the fermenter and the yeast consumes wort sugars converting them into alcohol and carbon dioxide. In one embodiment yeast is pitched and allowed to ferment the wort for eight days at 39-48 degrees Fahrenheit or any convenient time at any convenient temperature. In another embodiment yeast is pitched and allowed to ferment the wort for 48 hours or any convenient time. However, in alternate embodiments any known or convenient method to ferment wort can be used.

Next conditioning 1220 is completed. During conditioning the green beer is matured.

In one embodiment lagering is utilized which comprises of a secondary fermentation of the remaining fermentable extract at a reduced rate that is controlled by low temperatures and low yeast count. In another embodiment maturation is accomplished through bottle conditioning which involves secondary fermentation and clarification in the bottle induced by adding yeast and sugar to the beer. In another embodiment, secondary fermentation of cask-conditioned beers is induced by adding hops, sugars and yeast.

However, in alternate embodiments any known or convenient method to condition green beer can be used. After the step of conditioning 1220, filtration 1222 can be completed. Filtration is employed to remove residual yeast. In one embodiment powder filters using diatomaceous earth is used during filtration. In another embodiment depth filters are used for filtration made from a variety of materials, including melt-blown polypropylene, and polyester. However, in alternate embodiments any known or convenient method to filter beer can be used or filtration may not be conducted.

Next carbonation 1224 is completed. In one embodiment mechanical carbonation is accomplished by adding carbon dioxide gas to the filtered beverage. However, in alternate embodiments any known or convenient method to carbonate beer can be used. In the embodiment detailed above 1224, tea can be added in the amount of 2 lb per 5 gallons of beer. However, in alternate embodiments tea or other liquid-infusible substances can be added in any quantity to form a desired taste.

While this embodiment depicts tea as being added at step 1224, tea can be added before, after or during any of the steps described above. Various types of teas and amounts can be used. Furthermore while FIG. 12 and the associated description show the process of making tea infused beer, a similar process may be employed to make cider infused with any liquid infusible substance, using any known or convenient process to make cider.

While FIG. 12 and associated description describe one process for making beer, any known or convenient process can be used. Moreover while the steps of FIG. 12 are depicted in a specific sequence, the steps may be conducted in any known of convenient order. Additionally, in alternate embodiments additional known or convenient steps may be added and/or various steps may not be performed in order to produce various tastes and/or textures.

There are various changes and modifications that can be made as would be apparent to those skilled in the art. It is intended that the invention be limited only by the scope of the claims appended hereto.

What is claimed is:

1. A method of making a beverage comprising the steps of:
preparing a beverage;
infusing at least one liquid infusible substance into said beverage.

2. The method of claim 1 wherein said beverage is on of a beer and a malt beverage.

3. The method of claim 2 wherein said step of preparing a beverage includes the step of:
malting a mixture of barley kernels and water; and
wherein said step of infusing occurs after said step of malting.

4. The method of claim 2 wherein said step of preparing a beverage includes the step of:
kilning a mixture of barley kernels and water; and
wherein said step of infusing occurs concurrently with said step of kilning.

5. The method of claim 2 wherein said step of preparing a beverage includes the step of:
kilning a mixture of barley kernels and water; and
wherein said step of infusing occurs after said step of kilning.

6. The method of claim 2 wherein said step of preparing a beverage includes the step of:
mashing a mixture of barley kernels and water; and
wherein said step of infusing occurs concurrently with said step of mashing.

7. The method of claim 2 wherein said step of preparing a beverage includes the step of:
mashing a mixture of barley kernels and water; and
wherein said step of infusing occurs after said step of mashing.

8. The method of claim 2 wherein said step of preparing a beverage includes the step of:
boiling a mixture of barley kernels and water; and
wherein said step of infusing occurs concurrently with said step of boiling.

9. The method of claim 2 wherein said step of preparing a beverage includes the step of:
fermenting a mixture of barley kernels and water; and
wherein said step of infusing occurs concurrently with said step of fermenting.

10. The method of claim 2 wherein said step of preparing a beverage includes the step of:
filtering a mixture of barley kernels and water; and
wherein said step of infusing occurs concurrently with said step of filtering.

11. The method of claim 2 wherein said step of preparing a beverage includes the step of:
filtering a mixture of barley kernels and water; and
wherein said step of infusing occurs after said step of filtering.

12. The method of claim 1, wherein said beverage is a cider.

13. The method of claim 1, wherein said liquid infusible substance is a tea.

14. A beverage comprising:
water;
alcohol; and
residue from a liquid infusible substance
wherein at least one of said alcohol and said water has been infused with said liquid infusible substance.

15. The beverage of claim 14 wherein said alcohol is ethanol.

16. The beverage of claim 15 wherein said liquid infusible substance is a tea.

17. The beverage of claim 14 wherein said alcohol and said water are combined to form one of a beer and a malt beverage.

18. The beverage of claim 14 wherein said alcohol and said water are combined to form a cider.

19. The beverage of claim 14 wherein said liquid infusible substance is marijuana.

20. A method for preparing a beverage comprising the steps of:
combining barley kernels, and water to form a first mixture;
malting said mixture;
germinating said mixture;
kilning said mixture;
milling said mixture;
adding at least one liquid infusible substance to said mixture;
mashing said mixture to form wort;
separating said wort from said mixture;
boiling said wort-separated mixture;
chilling said wort-separated mixture;
fermenting said wort-separated mixture to form a liquid containing alcohol;
conditioning said wort-separated mixture;
filtering said wort-separted mixture;
carbonating said wort-separated mixture
